(19) United States
(12) Patent Application Publication
(10) Pub. No.: US 2006/0030219 A1
(43) Pub. Date: Feb. 9, 2006

(54) Phone jack for a 5.1 channel headphone

(76) Inventor: Jui-Shu Huang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/913,321

(22) Filed: Aug. 9, 2004

(51) Int. Cl. H01R 24/04

(52) U.S. Cl. 439/669

(57) ABSTRACT

A phone jack for a 5.1 channel headphone adapted to a 5.1 channel phone plug having a plurality of upper grooves arranged one after another on a top of a main body and at least six conductive pieces fitted into the upper grooves to establish a pressure contact with the electric terminals of the inserted phone plug. The 5.1 channel phone jack has an easy assembly and establishes a stable electric continuity with the phone plug, thereby resulting in an excellent transmission of 5.1 channel audio signals.

### BACKGROUND OF THE INVENTION

1. Field of the Invention

The invention relates to a phone jack for a 5.1 channel headphone, and more particularly, to a phone jack into which a multichannel phone plug is fitted.

2. Description of the Related Art

A phone plug, as shown in FIG. 1, is an elongated cylindrical terminal 10 to which conductive pieces 21, 22 are attached and which by insertion in a phone jack 20 for output of analog signals, establishes contact. The signals, as shown in FIG. 2, are transmitted through cable 14 to a speaker like earphone. The cylindrical terminal 10 has the convenience in operation and in use regarding the connection of sound signals.

However, the commercially available phone plug 10 has only few electric terminals, that is, the left and the right sound channels 11, 12 and the earth terminal 13, for creating a stereophonic effect and it can only transmit at most two audio signals. Consequently, the conventional headphones can only reach two-channel audio effect.

With the improvement of the digital technology and the popularization of the digital audio-video products like DVD players or surround amplifiers, they basically own the Dolby Digital and DTS decoding functions through which the digital signals are converted into analog signals for the speaker. Therefore, DVD players or the surround amplifiers include an analog output terminal of 5.1-channel audio signals for establishing a home theater system with TV, DVD player, surround amplifier and 5.1-channel speaker.

In order to reach the multichannel audio effect, several output terminals and sound signal cables have to be used for connection with the front, the center and the rear surround channels or the woofer. Accordingly, the AUDIO OUT terminal on the rear panel of the DVD player or the surround amplifier is connected with over six plugs and sound signal cables in order to transmit the sound signals to each of the speakers, thereby resulting in the cable clutter on the rear panel and, therefore, causing a great inconvenience.

5.1-channel or multichannel sound output brings the listeners an excellent enjoyment of the best sound effect. However, this will trouble someone who is at work and doesn't want to listen to the sound. When putting on headphone, the listeners can't enjoy the multichannel surround sound effect since the phone plug 10 can only reach the right and the left channel (two-channel) stereophonic effect.

In order to resolve the aforementioned problem, the inventor of the invention disclosed a multichannel phone plug (U.S. Pat. No. 6,394,852 B1) that teaches a single phone plug 30 for transmitting five or six audio signals. As shown in FIG.4, the phone plug 30 consists of a taper head 31, a first sleeve 32, a second sleeve 33, a third sleeve 34, a fourth sleeve 35, a fifth sleeve 36 and a ground sleeve 37 all of which are mounted one after another on the main body of the phone plug 30. Therefore, this phone plug 30 can transmit 5.1-channel phone plug 30. This has obtained many patents of different countries and is not the object of the invention so that no further descriptions are given hereinafter.

However, the above-mentioned phone plug 30 can't transmit the 5.1-channel signals if a corresponding phone jack is lacking. A phone jack 20, as shown in FIG. 2, has only two conductive pieces 21, 22 of different length. So, it is not suitable for use with the 5.1 channel phone plug 30. Based on this configuration of FIG. 2, an addition of further conductive pieces of different length to the phone jack 20 in accordance with the 5.1 channel phone plug 30 will cause difficulties in assembly. Meanwhile, the transmission of audio signals will be seriously deteriorated due to improper assembly.

### SUMMARY OF THE INVENTION

It is a primary object of the invention to eliminate the aforementioned drawbacks and to provide a 5.1 channel phone jack having a plurality of upper grooves arranged one after another on a top of a main body and a plurality of conductive pieces with the same figure for facilitating fabrication and assembly processes.

It is another object of the invention to provide a 5.1 channel phone jack in which each of the conductive pieces passes over an axial through hole of the phone jack and is correspondingly received within one of the upper grooves. This configuration permits a very simple assembly without using any other fixing elements. Moreover, the flexible portions of the conductive pieces corresponds to each other, thereby resulting in an smooth and stable continuity of electric contact between the conductive pieces and the phone plug and ensuring a better transmission effect of the 5.1 channel audio signal.

It is a further object of the invention to provide a 5.1 channel phone jack in which each of the conductive pieces is joined to an output terminal piece at their tail thereof. The conductive pieces are in contact with the output terminal pieces, respectively before the phone plug is fitted into the phone jack. This allows an electric connection of the multi-channel audio signals which are transmitted by the output terminal pieces to other speakers. In inserting the phone plug into the phone jack, the conductive pieces are lifted away from the output terminal pieces, thereby establishing contact between the phone plug and the conductive pieces. This allow a smooth transmission of audio signals from the conductive pieces 50 to the phone plug for their output.

It is still another object of the invention to provide a 5.1 channel phone jack in which a detection piece is disposed in connection with an audio control unit for automatically regulating the 5.1 channel output signal. So, the headphone to which the phone plug is attached, provides the listeners with a more proper volume and audio effect.

### BRIEF DESCRIPTION OF THE DRAWINGS

The accomplishment of this and other objects of the invention will become apparent from the following descriptions and its accompanying drawings of which:

FIG. 1 is a schematic drawing of a conventional phone plug;

FIG. 2 is a schematic drawing of a conventional phone jack;

FIG. 3 is a perspective view of a phone jack for a 5.1 channel headphone in accordance with the invention;

FIG. 3A is a perspective view of first engaging slots in accordance with the invention;

FIG. 4 is a perspective view of the phone jack for a 5.1 channel headphone in accordance with the invention before insertion of a phone plug;

FIG. 5 is a perspective view of the phone jack for a 5.1 channel headphone in accordance with the invention after insertion of the phone plug;

FIG. 6 is a side view of the phone jack for a 5.1 channel headphone in accordance with the invention;

FIG. 7 is a cutaway view taken along the line 7-7 of FIG. 5;

FIG. 8 is a cutaway view taken along the line 8-8 of FIG. 6;

FIG. 9 is a cutaway view taken along the line 9-9 of FIG. 7;

FIG. 10 is a cutaway view taken along the line 10-10 of FIG. 7; and

FIG. 11 is a perspective view of the invention formed as an adapter for a phone plug.

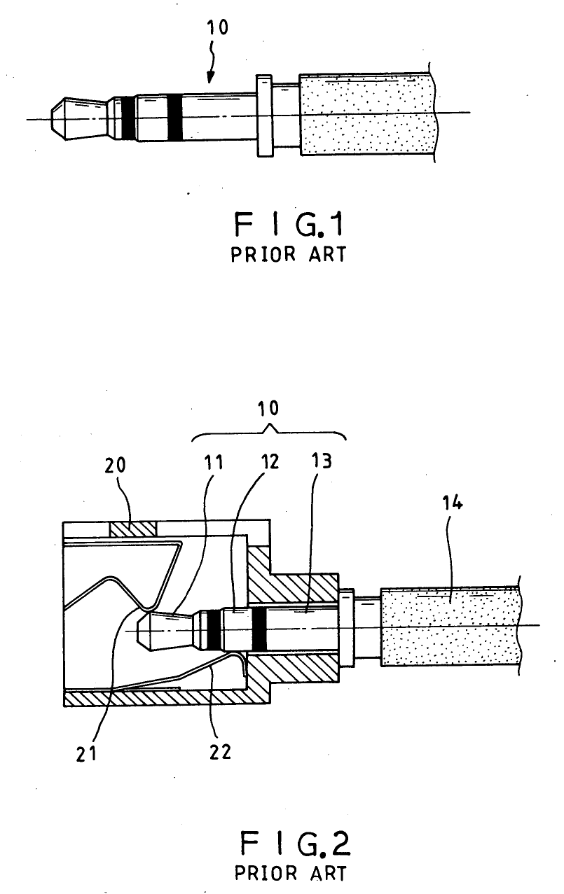

### DETAILED DESCRIPTION OF THE PREFERRED EMBODIMENT

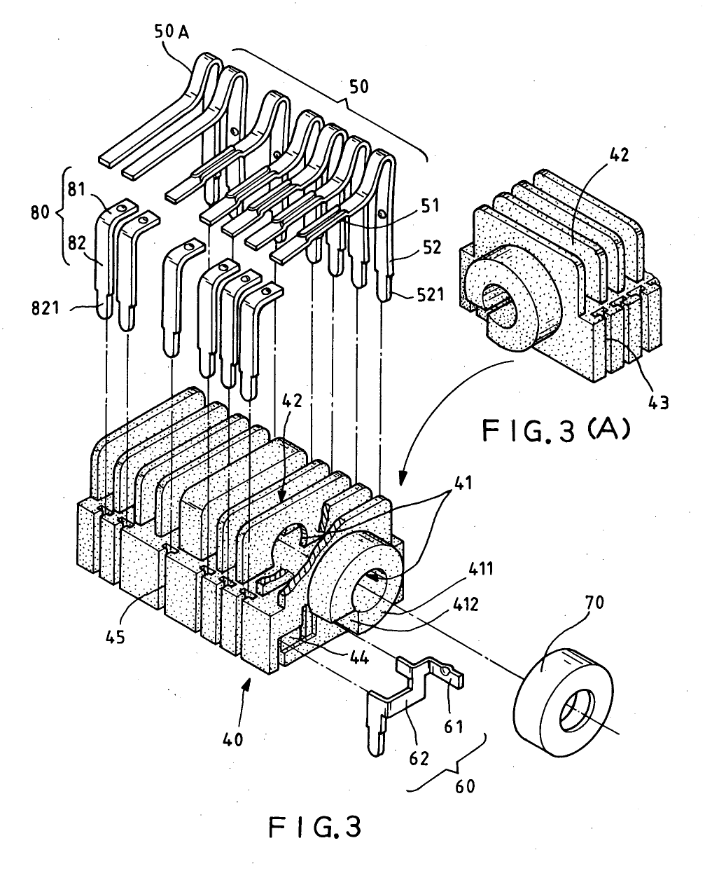

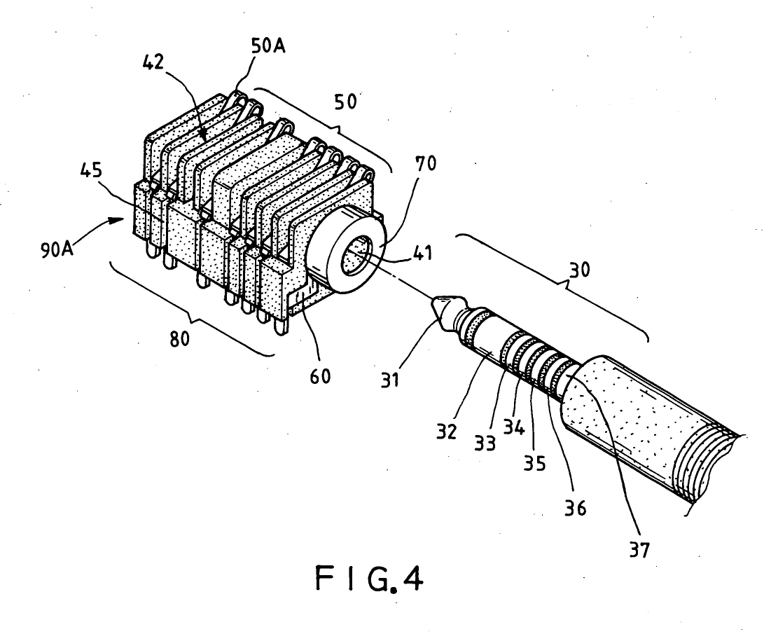

First of all, referring to FIGS. 3 and 4, a phone jack for a 5.1 channel headphone in accordance with the invention at least includes:
a main body 40 having an axial through hole 41 with a depth corresponding to the length of a phone plug 30, the main body 40 further having a plurality of upper grooves 42 in an upper portion thereof and first engaging slots 43 in a side portion thereof (see FIG. 3);
at least six conductive pieces 50 each having a flexible portion 51 and a fixing portion 52, the fixing portions 52 being fitted into the respective first engaging slots 43, the flexible portions 51 passing over the axial through hole 41 and being received within the respective upper groove 42;
a ground terminal 60 mounted on a front side of the main body 40, the ground terminal 60 having a flexible contact piece 61 positioned within an annular portion 411 of the main body 40 and exposed on the inner side of the annular portion 411, the ground terminal 60 further having a fixing portion 62 received within a front groove 44 of the main body 40; and
an end cap 70 mounted on the annular portion 411 of the main body 40.

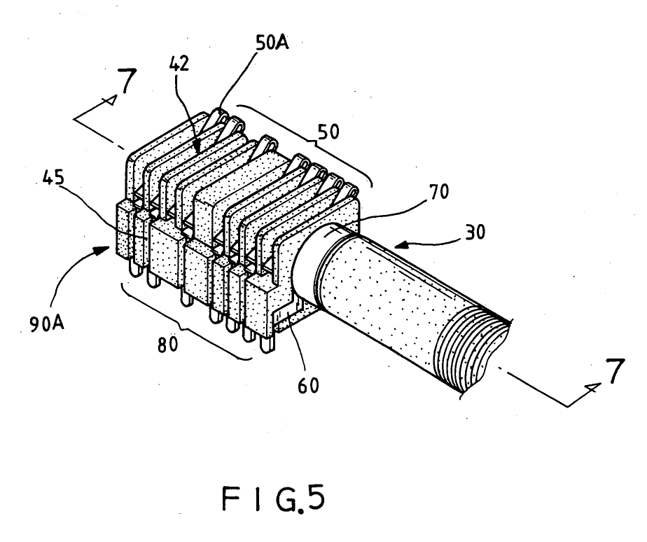

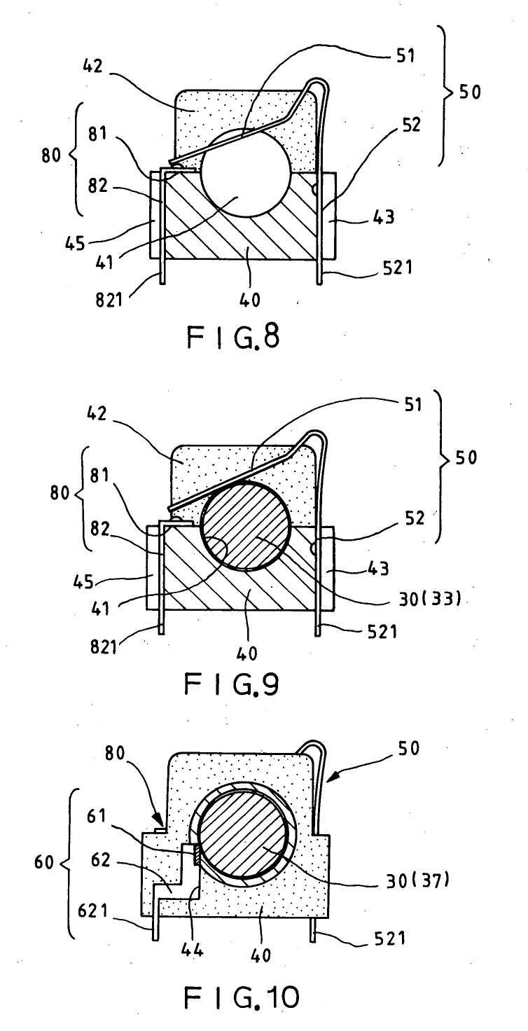

Based on the above-mentioned configuration, all of the conductive pieces 50 are brought into the respective first engaging slots 43 of the main body 40 by use of a automation machine tool such that the flexible portion 51, as shown in FIG. 8, passes over the axial through hole 41 and is correspondingly received within one of the upper grooves 42. This configuration permits a very simple assembly without using any other fixing elements. Moreover, the flexible portions 51 of the conductive pieces 50 corresponds to each other, thereby resulting in an smooth and stable continuity of electric contact between the conductive pieces 50 and the phone plug 30 when the phone plug 30, as shown in FIG. 5, is inserted into the phone jack 90A.

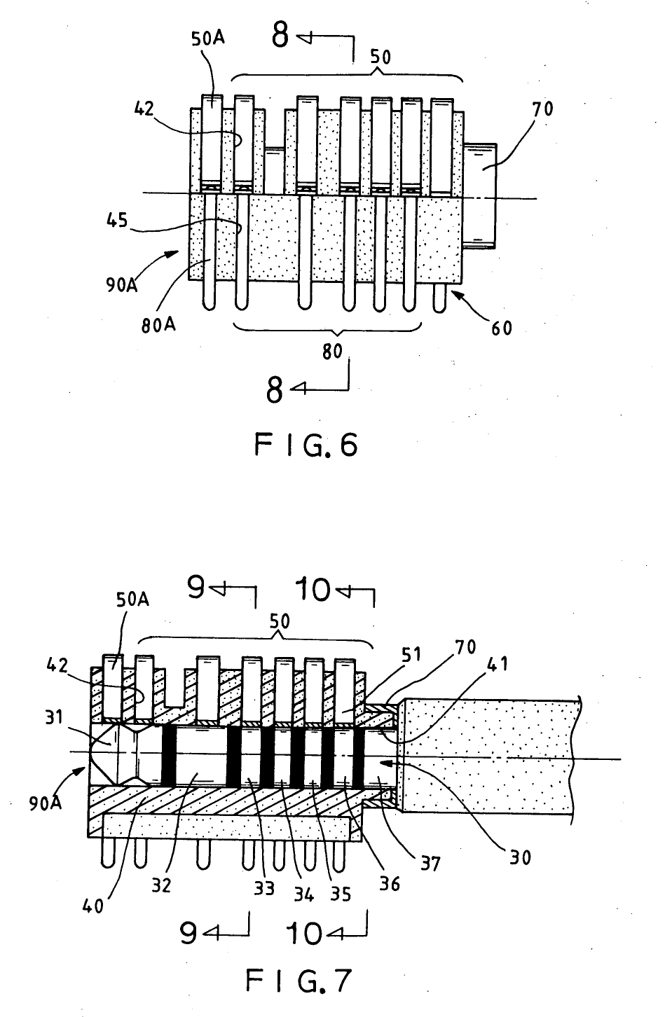

Again, referring to FIGS. 3 and 4, another feature of the invention is shown. After placing the conductive pieces 50 within the respective upper grooves 42, tails of their flexible portions 51 are positioned over output terminal pieces 80, respectively. The output terminal pieces 80 each having an inverted L-shape include a contact portion 81 extending in the horizontal direction and a fixing portion 82 extending in the vertical direction. The fixing portions 82 are fitted into second engaging slots 45 opposing to the first engaging slots 43, respectively. As shown in FIGS. 6 and 8, the flexible portion 51 of the conductive pieces 50 is in contact with the contact portion 81 of the output terminal piece 80 before the phone plug 30 is fitted into the axial through hole 41. This allows an electric connection of the multi-channel audio signals which are transmitted by the conductive pieces 50 and the output terminal pieces 80 to other speakers (not shown).

As shown in FIGS. 7 and 9, the phone plug 30 is fitted into the axial through hole 41. The flexible portions 51 of the conductive pieces 50 are lifted to apply pressure on a taper head 31, a first sleeve 32, a second sleeve 33, a third sleeve 34, a fourth sleeve 35 and a fifth sleeve 36. Meanwhile, the conductive piece 50, as shown in FIG. 9, rises away from the output terminal piece 80 while the ground terminal 60 remains in contact with the phone plug 30. As shown in FIGS. 7 and 10, the flexible contact piece 61 of the ground terminal 60 is brought in contact with a ground sleeve 37 of the phone plug 30. Therefore, the conductive pieces 50 and the ground terminal 60 for input of audio signals permit an electric multipolar continuity, thereby resulting in a smooth transmission of 5.1 channel signals from the phone plug 30 to a multi-channel headphone (not shown).

In addition, the conductive pieces 50 of the invention are extended over the upper grooves 42 and establish a pressure contact with all terminals on the phone plug 30. So, only little space is occupied in spite of the configuration with six conductive pieces 50 which are stably secured within the main body 40. Furthermore, a detection piece 50A together with a corresponding terminal piece 80A, as shown in FIGS. 6 and 7, are fitted to the rear end of the main body 40. As shown in FIGS. 6 and 7, the shape of the detection piece 50A corresponds to that of the conductive pieces 50. When the phone plug 30 is completely fitted into the axial through hole 41, the detection piece 50A is lifted away from the terminal piece 80A in disconnection state. An audio control unit (not shown) in connection with the detection piece 50A and the terminal piece 80A automatically regulates the output signal after receiving the insertion signal of the phone plug 30. For example, the volume is turned down to provide an optimal volume output for the headphone. The audio control unit is not the object of the invention so that no further descriptions thereto are given hereinafter. So, the 5.1 channel phone jack of the invention features a perfect provision of corresponding contact signals of the phone jack 90A to the phone plug 30 without occupying much space. Besides, a detection piece 50A is provided for a more comfortable listening enjoyment.

Furthermore, as shown in FIGS. 8 and 9, the conductive pieces 50 (including the detection piece 50A), the ground terminal 60 and the output terminal pieces 80 (including the terminal piece 80A) are respectively formed with an extension part 521, 621, 821 at the open end thereof through which the jack is directly joined to a circuit board (not shown) within a stereo system or soldered to respective signal cables (not shown) for simplifying the assembly work.

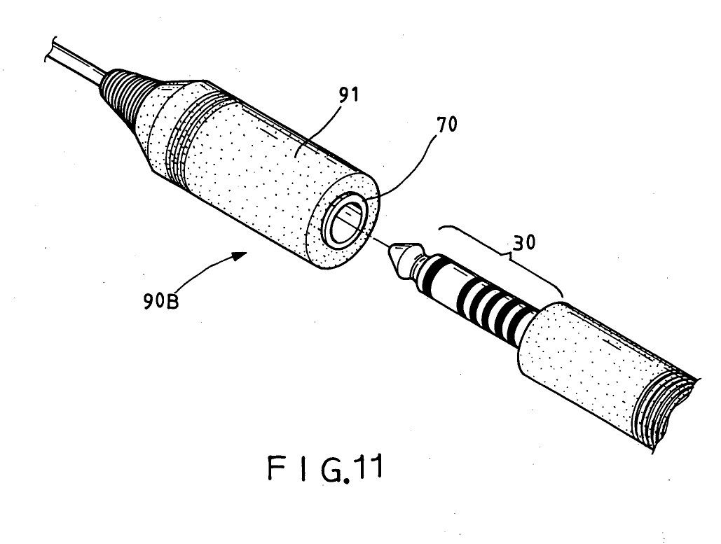

The invention has a small configuration so that it's easy to install the phone jack 90A in the back of the stereo system to be 5.1 channel output. As shown in FIG. 11, the main body can be alternatively wrapped with an insulation layer 91 to form an adapter 90B for the 5.1 channel phone plug. The configuration of the adapter 90B completely corresponds to the aforementioned 5.1 channel phone jack so that no further descriptions thereto are given hereinafter.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A phone jack for a 5.1 channel headphone comprising:
a) a main body having an axial through hole with a depth corresponding to the length of a phone plug, the main body further having a plurality of upper grooves in an upper portion thereof and first engaging slots in a side portion thereof;
b) at least six conductive pieces each having a flexible portion and a fixing portion, the fixing portions being fitted into the respective first engaging slots, the flexible portions passing over the axial through hole and being received within the respective upper grooves;
c) a ground terminal mounted on a front side of the main body, the ground terminal having a flexible contact piece positioned within an annular portion of the main body and exposed on the inner side of the annular portion, the ground terminal further having a fixing portion received within a front groove of the main body; and
d) an end cap mounted on the annular portion 411 of the main body.

2. The phone jack for a 5.1 channel headphone as recited in claim 1 wherein, after placing the conductive pieces within the respective upper grooves, tails of their flexible portions are positioned over output terminal pieces, respectively, each of which owns an inverted L-shape and includes a contact portion extending in the horizontal direction and a fixing portion extending in the vertical direction, and wherein the fixing portions are fitted into second engaging slots opposing to the first engaging slots, respectively.

3. The phone jack for a 5.1 channel headphone as recited in claim 2 wherein the flexible portions of the conductive pieces are lifted away from the output terminal pieces, respectively when the phone plug is fitted into the axial through hole.

4. The phone jack for a 5.1 channel headphone as recited in claim 2 wherein the main body further comprising a detection piece together with a corresponding terminal piece both of which are fitted to the rear end of the main body.

5. The phone jack for a 5.1 channel headphone as recited in claim 1 wherein the conductive pieces, the ground terminal and the output terminal pieces are respectively formed with an extension part at the open end thereof.

6. The phone jack for a 5.1 channel headphone as recited in claim 1 wherein the main body is alternatively wrapped with an insulation layer to form an adapter for the phone plug.
